(19) United States
(12) Patent Application Publication
(10) Pub. No.: US 2014/0227487 A1
(43) Pub. Date: Aug. 14, 2014

(54) IDENTIFICATION DOCUMENT AND METHOD OF PRODUCING THE SAME

(71) Applicant: DATACARD CORPORATION, Minnetonka, MN (US)

(72) Inventor: Dennis J. Warwick, Richfield, MN (US)

(73) Assignee: DATACARD CORPORATION, Minnetonka, MN (US)

(21) Appl. No.: 14/180,045

(22) Filed: Feb. 13, 2014

Related U.S. Application Data
(60) Provisional application No. 61/764,302, filed on Feb. 13, 2013.

(51) Int. Cl. B42D 25/00; B41J 2/44

(52) U.S. Cl. CPC B42D 15/10; B41J 2/442
USPC 428/159; 347/262; 428/158

(57) ABSTRACT

An identification document includes a first surface, at least a portion of the first surface being made of foamable synthetic material, and a tactile relief marking having a bubble structure formed in the foamable synthetic material. A method is used for producing at least one tactile relief marking on an identification document by an irradiation source. The identification document includes a surface having foamable synthetic material that has a property of increasing its volume by foaming upon application of energy. The method includes selectively irradiating the foamable synthetic material with energy to cause the foamable synthetic material to foam, thereby forming a tactile relief marking

### FIELD

This disclosure relates generally to identification documents including secure documents such as identification cards, driver's licenses, passports and the like, as well as non-secure documents such as store loyalty cards, phone cards and the like. More particularly, this disclosure relates to a tactile relief feature that is formed on an identification document.

### BACKGROUND

Identification documents, such as identification cards, passports, credit and debit cards, store loyalty cards, and phone cards, are personalized with information concerning the particular documents and then issued to a document holder. Personalization and issuance are typically handled by government agencies, credit card companies, or entities authorized to handle the personalization and issuance process.

As part of the personalization and issuance process, the identification documents can undergo a number of personalization procedures, including printing, photoprinting, magnetic stripe and/or chip encoding, embossing, lamination of protective laminates, and other known procedures.

So called clear laser marking has been available to personalize the identification document for several years. Clear laser marking involves the use of a laser source to melt the surface of an identification document in order to leave a barely visible mark. So far, this type of marking has been used for numbers and dates but not images. Normally, when 1064 nm wavelength laser energy is applied to the identification document material, the material will turn black; therefore, a different wavelength laser such as a 10,600 nm wavelength laser (e.g., a CO₂ laser) is required to avoid having the material turn black.

However, variations in material properties and laser performance easily can lead to inconsistent marking. In such circumstances, missing portions of letters and numbers may occur. Also, this type of marking can only be seen in reflected light, but cannot be felt since it does not significantly raise the surface of the identification document.

### SUMMARY

Some embodiments of an identification document may be configured to comprise a first surface having a tactile relief marking, thereby allowing the marking on the identification document to be sensed by touch. The identification document also includes a second surface opposite to the first surface, devoid of a negative relief marking directly opposite to the relief marking on the first surface. In such circumstances, the identification document may comprise a relief marking made of a foamed synthetic material including bubbles therein.

In some embodiments, the relief marking may be configured to present a non-black color. For example, the relief marking may present a generally gold color, which is typically not reproducible by conventional laser marking techniques. Other embodiments may comprise a relief marking that presents a color that is different from the non-irradiated portions such that the relief marking is more easily perceivable visually. In further embodiments, the foamed relief marking is sufficiently transparent such that an image contained on a layer below is visible through the relief marking

In some embodiments, the relief marking has a generally uniform stroke width.

In other embodiments, the bubbles contained in the tactile relief marking have diameters that are in a range up to about 100 μm.

Some embodiments may comprise a tactile relief marking overlapping with at least a portion of a secondary marking, thereby deterring attempts to tamper with the relief marking or the secondary marking. In some other embodiments, a laser source may be used to produce both a secondary marking and a tactile relief marking In further embodiments, no additional radiation source such as a CO₂ laser is needed to prevent the identification document material from turning black.

In particular embodiments, an identification document may comprise a first surface, at least a portion of the first surface being made of foamable synthetic material, and a tactile relief marking having a bubble structure formed in the foamable synthetic material.

Other embodiments may include a method for producing at least one tactile relief marking on an identification document by an irradiation source. The identification document includes a surface having foamable synthetic material that has a property of increasing its volume by foaming upon application of energy. The method comprises selectively irradiating the foamable synthetic material with energy to cause the foamable synthetic material to foam without being destroyed, thereby forming a tactile relief marking.

These and other embodiments described herein may provide one or more of the following benefits. First, some embodiments of the identification documents may comprise a tactile relief marking made of a foamed synthetic material including bubbles therein. For example, the relief marking has a raised surface, thereby allowing the marking on the identification document to be sensed by touch. Second, the relief marking may be configured to present a non-black color, thereby enhancing effectively color and hue of the identification document. Third, the tactile relief marking may be configured to overlap with at least a portion of a secondary laser marking, thereby deterring attempts to tamper with the relief marking or the secondary marking. Fourth, only one laser source is needed to produce both a secondary marking and a tactile relief marking. In such circumstances, no additional radiation source such as a CO₂ laser is needed to prevent the identification document material from turning black. As a result, the process is simplified and the costs are reduced.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 illustrates an identification document including tactile relief markings.

FIG. 2A is a schematic cross sectional view of one embodiment of a multilayer identification document.

FIG. 2B is a schematic cross sectional view of a further embodiment of a section of the multilayer identification document.

FIG. 3 is a close-up view of the tactile relief numbers on the identification document of FIG. 1.

FIG. 4 is a close-up view of a portion of a tactile relief image on the identification document of FIG. 1.

FIG. 5 illustrates a portion of a relief number, showing bubbles therein.

Like reference symbols in the various drawings indicate like elements.

### DETAILED DESCRIPTION

As used herein, the term “identification document” refers generally to a document bearing identifying data about the document holder, including but not limited to credit cards, bank cards, phone cards, store loyalty cards, passports, driver's licences, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards and badges.

The term “tactile” refers generally to sensible by a human being by touch.

The term “marking” or the term “markings” refer generally to symbols, characters or other appropriate indicia, such as letters, numbers, figures, images, photos, decorations, or the like.

The term “tactile relief marking” refers generally to a relief marking that is raised above the adjacent surface by about 0.10 mm to 0.30 mm.

The term “stroke width” refers generally to a spatial distance between a first side and a second side of a stroke in a direction transverse to a longitudinal direction of the stroke.

The term “transparent” refers generally to transparent, translucent, or more generally, permitting visible light to transmit therethrough in the visible spectrum.

The term “diameter” of a bubble contained in a tactile relief marking refers to a greatest distance of a straight line segment passing through a center axis of a bubble and terminating at the periphery of the bubble.

The term “line-art” refers to a line segment, e.g., a straight or curved segment of finite length.

The term “secondary marking” refers to a marking that is not raised or a marking that is raised above the adjacent surface by about 0.02 mm to about 0.10 mm.

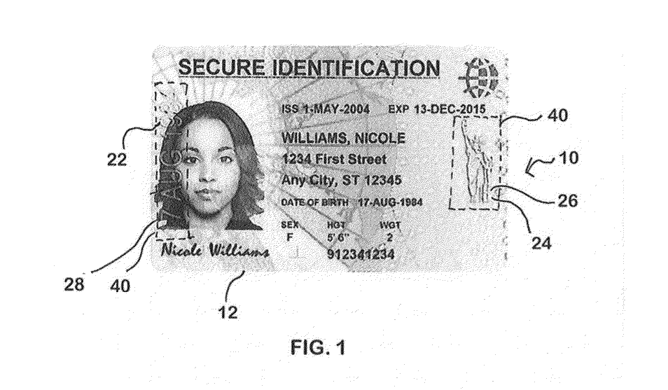

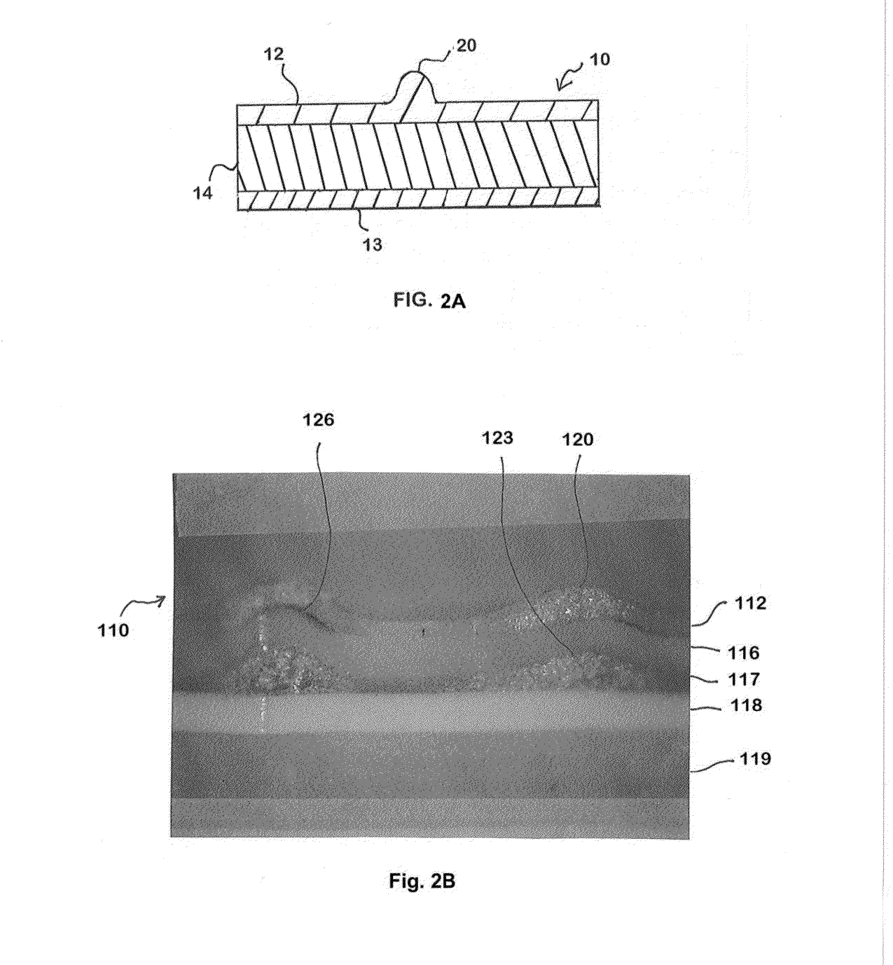

Referring to FIGS. 1, 2A and 3-4, a multilayer identification document 10 comprises at least one laser reactive layer and a substrate layer 14. In the depicted embodiment as shown in FIG. 2A, the identification document 10 comprises a substrate layer 14 and first and second surface layers 12, 13 disposed on opposite sides of the substrate layer 14. In some embodiments, at least the first surface layer 12 is made of a laser reactive synthetic material, in which at least one tactile relief marking 20 is formed. It is to be understood that one or more other layers can be present in the identification document 10. For example, in some embodiments, one or more additional layers can be present between the substrate layer 14 and the first surface layer 12 and/or in other embodiments one or more additional layers can be present above the first surface layer 12. In some embodiments, one or more additional layers can be present between the substrate layer 14 and the second surface layer 13 and/or in other embodiments one or more additional layers can be present below the second surface layer 13.

In some embodiments, the first surface layer 12 may have a thickness ranging from about 50 um to about 400 um, and preferably from about 50 um to about 200 um. However, it is to be understood that the surface layer 12 can have any thickness suitable for a surface layer of an identification document 10.

The synthetic material constituting the first surface layer 12 employed in the present method may be any synthetic material suitable for a surface layer of an identification document 10. A wide variety of materials can be used to make the first surface layer 12, including a single polymer such as polyolefin, polyester or polycarbonate, or a composite structure of different types of polymers or in some applications metal.

In some embodiments, the synthetic material is optically transparent in the visible spectrum and capable of absorbing infrared radiation. For example, the synthetic material can form a foamed structure when irradiated by a laser beam. The synthetic material can also contain additives, for example small particles such as metal particles, to provide various visual effects. Preferably, the additives are uniformly dispersed in the synthetic material to allow more uniform reaction to the applied laser energy when producing the tactile relief marks. The synthetic materials are available in a variety of configurations. Additives can be used to impart or improve infrared absorbing properties for base materials that exhibit weak infrared absorbance. An example of a suitable synthetic material is Makrofol ID 6-2 available from Bayer AG of Leverkusen, Germany.

Referring to FIG. 2B, in some embodiments, a section of a multilayer identification document 110 may comprise a first laser reactive layer 112, a non-laser reactive layer 116, a second laser reactive layer 117, a white layer 118 and a clear layer 119. It is to be noted that one or more layers can be disposed above the first laser reactive layer 112 or beneath the white layer 118. A marking 126 is formed between the first laser reactive layer 112 and the non-laser reactive layer 116, such that the marking 126 is visible through the first laser active layer 112. The first laser reactive layer 112 is made of a first laser reactive synthetic material, in which at least one tactile relief marking 120 is formed, and the second laser reactive layer 117 is made of a second laser reactive synthetic material, in which at least one tactile relief marking 123 is formed. It is to be understood that the first and second laser reactive synthetic materials can be the same material or different materials. Also, in some embodiments, the first and second laser reactive layers 112, 117 can be disposed next to each other without any layer disposed in between.

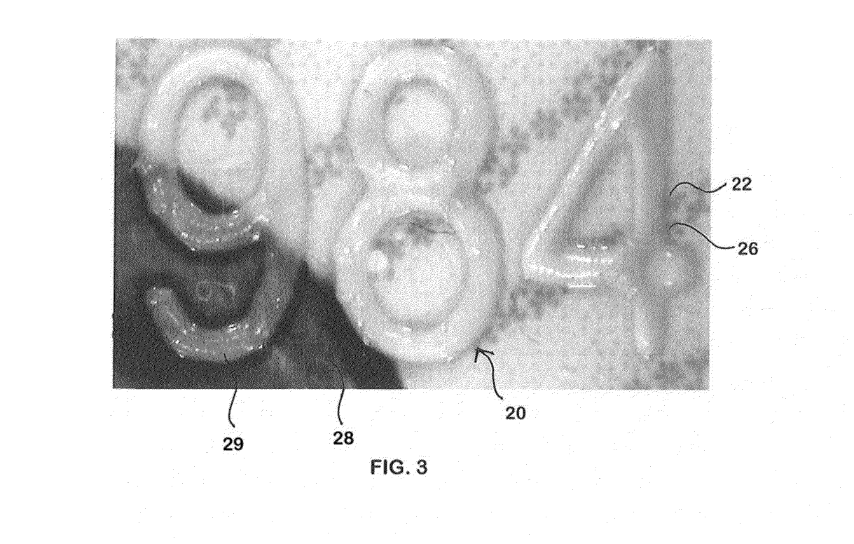

The embodiment depicted in FIGS. 1, 2A and 3-4 will be described in more detail below as an illustrative example of the identification document. However, it is to be understood that the embodiment depicted in FIG. 2B has similar features. As shown in FIG. 3, the first surface layer 12 of the identification document is made of transparent synthetic material, allowing background markings 26 formed on the substrate layer 14 or other layers underneath the first surface layer 12 to be visible through the first surface layer 12.

In the depicted embodiment as shown in FIGS. 1 and 2A, a number of tactile relief markings 20 are formed, including relief characters 22 and a relief FIG. 24. It is to be understood that although the embodiments depicted in FIGS. 1 and 2A are multilayer identification documents, the tactile relief marking 20 may also be formed on a surface of a single layer identification document. The relief marking 20 is raised up above the adjacent surface of the first surface layer 12, thereby allowing the marking 20 to be sensed by touch. In some embodiments, the relief marking 20 is raised above the adjacent surface of the first surface layer 12 by about 0.10 mm to about 0.30 mm, and preferably by about 0.20 mm.

In the depicted embodiment as shown in FIG. 2A, only the first surface layer 12 of the identification document 10 includes the relief marking 20. However, it is also to be understood that the relief marking 20 can also be formed on both the first and second surface layers 12, 13.

Referring to FIG. 2A, in some embodiments, the tactile relief marking 20 is formed on the first surface layer 12, while the second surface layer 13 is devoid of a negative relief marking such as an indentation directly opposite to the relief marking 20 on the first surface layer 12. Therefore, the relief marking 20 differs from an embossed character which has a negative indentation directly opposite the embossed character.

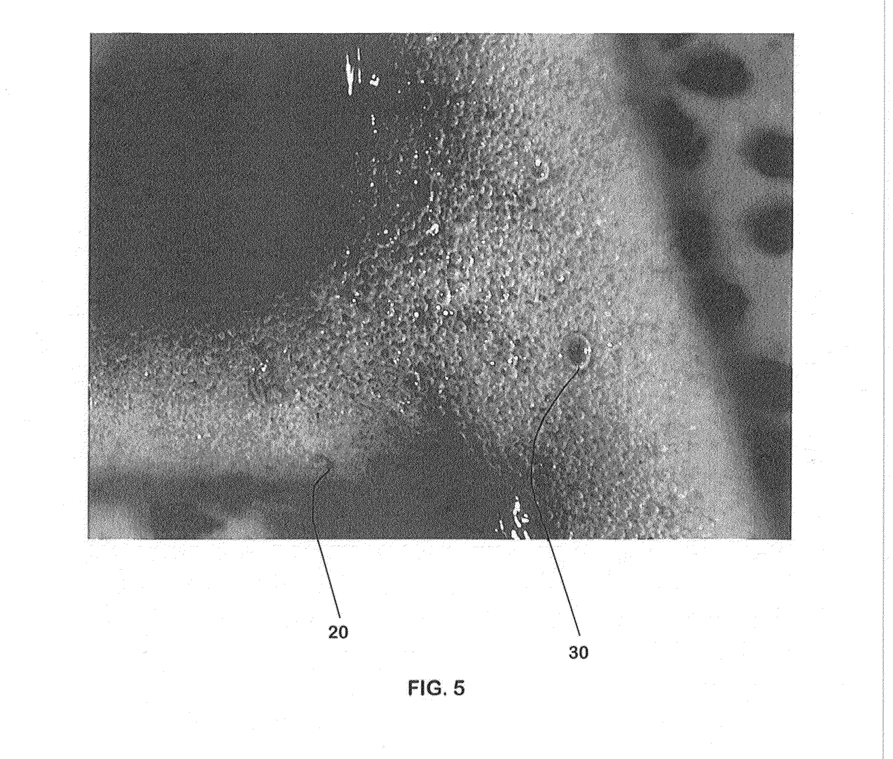

Referring now to FIG. 5, in some embodiments, the relief marking 20 is made of a foamed synthetic material including bubbles 30 therein. Formation of the relief marking 20 including the bubbles 30 will be described in detail below. In some embodiments, the bubbles 30 contained in the relief marking 20 have diameters that are in a range up to about 100 μm.

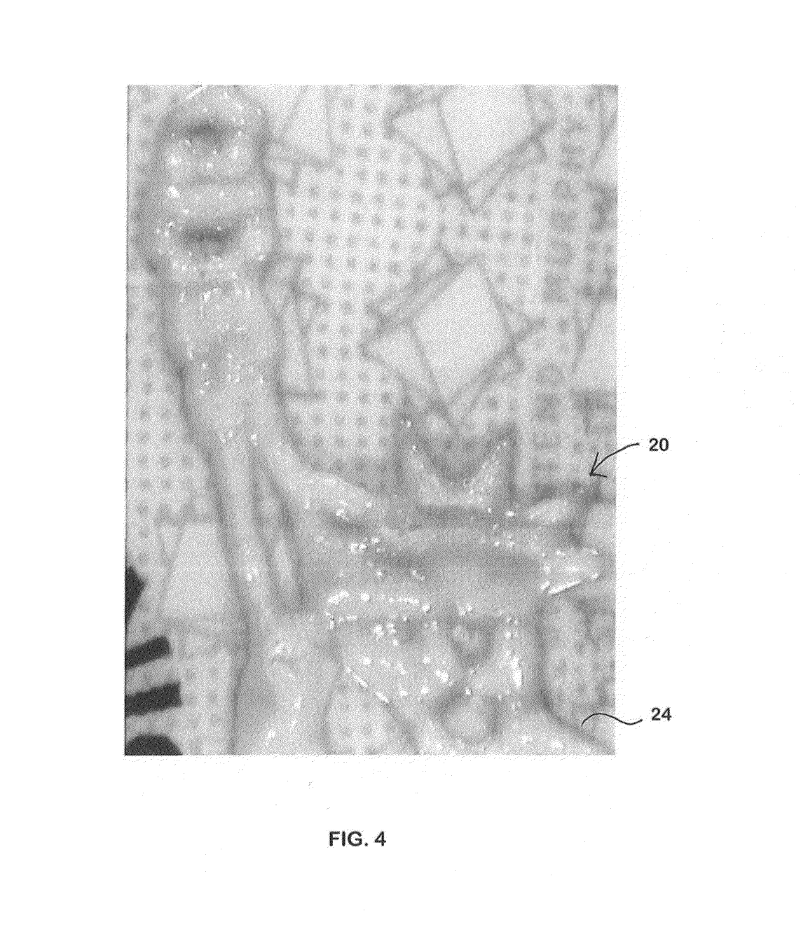

Referring to FIGS. 1 and 3-5, in some embodiments, each stroke of the relief marking 20 has a generally uniform stroke width. For example, each stroke of the relief characters 22 and relief FIG. 24 includes a uniform stroke width, respectively. In the depicted embodiment as shown in FIGS. 1 and 4, the relief FIG. 24 is in line-art format. In some embodiments, the stroke width is about 0.5 mm or more. In other embodiments, the relief characters 22 or relief FIGS. 24 include non-uniform stroke width, or even encompass a relatively large and broad area such as a square.

Referring to FIGS. 1 and 3-5, in some embodiments, the synthetic material forming the relief marking may present a non-black color when forming the foamed structure. For example, the relief marking 20 may present a generally gold color, thereby enhancing effectively color and hue of the identification document 10. Alternatively, the relief marking 20 may present a generally white appearance due to diffusion of light by the bubble surfaces. Other embodiments may comprise a synthetic material forming the relief marking 20 that presents a color that is different from the non-tactile portions such that the relief marking 20 is more easily visually perceivable.

Referring to FIG. 3, in some embodiments, the relief marking 20 is sufficiently transparent such that background markings 26 contained on the substrate layer 14 are visible through the relief marking 20.

Still referring to FIG. 3, some embodiments of the identification document 10 may comprise a relief marking 20 overlapping with at least a portion 29 of a secondary marking 28, thereby deterring attempts to tamper with the relief marking 20 or the secondary marking 28. This security feature will be described in more detail below.

Referring back to FIG. 1, to produce a desired relief marking 20, in some embodiments, a laser beam is irradiated on the first surface layer 12, in a pattern such as characters, figures or other symbols. For example, a laser source, such as a laser marker irradiating spots of about 50 um, may be employed to produce details for the relief marking 20. In some embodiments, unlike the normal black marking produced by highly concentrated laser energy, the tactile relief marking 20 is produced by lower energy density with localized heating.

When the relief marking 20 is being produced, a laser beam is irradiated at a printing region 40 defined on the first surface layer 12. On the basis of the dimensions of printing region 40, control data for producing the relief marking 20 are calculated. The laser beam is then guided along a predetermined path within the printing region 40 to form the relief marking 20. The properties of the laser beam are selected to allow the laser energy to be applied to the synthetic material in such a way that it forms a foamed relief marking. An example of the laser source suitable for such synthetic material is a laser marker having a wavelength of about 1064 nm. The synthetic material suitable for this process typically includes laser reactive synthetic materials.

Upon application of the laser beam, the portion of the surface layer irradiated with the laser beam absorbs infrared radiation and forms small bubbles 30 such that the synthetic material is expanded and foamed. This causes a corresponding volume expansion above the adjacent surface of the first surface layer 12. These portions become a relief marking of a character, figure, or other symbols. Since the relief marking 20 is formed by expansion and foaming of the synthetic material, a sufficient abrasion resistance and durability may be retained even when the marking is frequently abraded during use.

Referring to FIGS. 1 and 3-5, a color difference also may be produced between the irradiated relief marking 20 and the non-irradiated portions of the first surface layer 12, thereby allowing the printing effect to be further enhanced.

The laser energy being applied can be adjusted in a variety of manners, such as adjusting the laser energy by a laser power level, a pulse density, pulse duration, etc.

Different synthetic materials require different settings to achieve desired results. For example, depending on the shape of the intended relief marking 20, laser energy can be varied to better control the bubbling process, thereby allowing more consistent shaping. For example, a same level of laser energy was used in every part of the characters in FIG. 3 to produce the relief characters 22. At the cross points of lines defining the image, laser energy can be reduced to achieve a more even height.

Still referring to FIGS. 1 and 3-5, in some embodiments, the relief marking 20 produced by irradiation of a laser beam is non-black. For example, an irradiated portion was heated relatively slowly to allow bubbles to form. The laser beam can be adjusted out of focus to allow the beam spot to overlap with an adjacent irradiated portion, thereby avoiding blackening the material. With these settings, a laser beam heats the synthetic material enough to cause it to foam but the energy irradiated by the laser beam is controlled to be low enough to prevent the synthetic material from turning black. In some embodiments, the color of the relief marking varies from generally white to a generally gold or brown depending on the material and the characteristics of laser energy. This is distinctly different from a normal black laser marking color. In a particular embodiment, the relief marking 20 has a generally gold color, which is typically not reproducible by normal laser marking techniques.

Still referring to FIGS. 1 and 3-5, in some embodiments, the tactile relief marking 20 can be produced by scanning in rows and columns to make the marking 20, similar to the technology used in raster or bitmap marking. In other embodiments, the tactile relief marking 20 can be formed by drawing a line for example an outline to form the shape of an image or character, similar to the technology used in vector marking.

Referring to FIG. 3, some embodiments may comprise a tactile relief marking overlapping with at least a portion of a secondary marking, thereby deterring attempts to tamper with the relief marking or the secondary marking In some embodiments, when a non-black tactile relief marking 20 is formed on the first surface layer 12, a secondary marking 28 can be formed on top of the non-black tactile relief marking 20. As a result, a portion 29 of the secondary marking 28 is overlapped with the tactile relief marking 20. It is to be noted that as shown in FIG. 3, the overlapped portion 29 may present a color that is lighter than the color of the secondary marking 28. This is caused by diffusion of light by surfaces of the bubbles formed in the tactile relief marking 20. The overlap of the secondary marking 28 and the tactile relief marking 20 will help deter attempts to tamper with the tactile relief marking 20 or the secondary marking 28. This is because, in some embodiments, burning will occur when a tactile relief marking 20 is formed after or on top of the secondary marking 28. That is, in these embodiments, when a tactile relief marking 20 is formed after or on top of the secondary marking 28, alteration of the non-black tactile relief marking 20 or the secondary marking 28 will cause burning and material destruction. As a result, tampering with either the non-black tactile relief marking 20 or the secondary marking 28 is deterred. It is to be understood that the secondary marking can also be in any other colors, such as generally brown, generally grey, generally light brown, generally light grey. In some embodiments, the secondary marking can be any dark color, such as dark grey. In the embodiment depicted in FIG. 3, the secondary marking presents a black color.

It is to be understood that in some embodiments, the secondary marking 28 is formed in the thickness of the first surface layer 12, instead of on a surface of the first surface layer 12. As a result, the secondary marking cannot be removed by solvents, abrasion, etc., which are used to remove markings formed on a surface of a layer. In such circumstance, overlapping of the secondary marking 28 with a tactile relief making 20 makes it even more difficult to remove a personalization element, i.e., the tactile relief marking 20 or the secondary marking 28, and replace the personalization element with a substitution element, such as false information.

To produce the secondary marking 28, a laser beam can be used to treat a clear, first surface layer 12 in such a way that the application of laser energy causes the clear surface layer to blacken. For example, a laser beam can be used to irradiate a portion of a non-black tactile relief marking 20 in such a way that the application of laser energy causes the non-black tactile relief marking 20 to blacken. Typically, a small amount of energy results in a small amount of blackening while a larger amount of energy causes a large amount of blackening, depending on the type of laser used. Increasing the energy even further, the synthetic material may be burned. In one embodiment, a laser source is configured to deliver high energy pulses at about 1 μm wavelength with a duration ranging from about 10 nsec to about 500 nsec to produce black markings

In one application, a tactile relief marking can be used to overlap over a laser photo to deter attempts of photo substitution. In some embodiments, the laser photo can be formed on top of the tactile relief marking to deter tampering of the photo.

In some embodiments, by means of the same laser source for producing a secondary marking 28, the tactile relief marking 20 can be produced on the identification document 10. An example of a suitable laser source is a YLP Series Fiber Laser from IGP Photonics of Oxford, Mass., United States. In such circumstances, no additional laser source such as a CO₂ laser is needed to prevent the identification document material from turning black. In alternative embodiments, a CO₂ laser can be used to assist in producing the tactile relief marking 20.

A number of embodiments of the invention have been described. Nevertheless, it will be understood that various modifications may be made without departing from the spirit and scope of the invention.

1. An identification document, comprising:
a first surface, at least a portion of the first surface being made of foamable synthetic material, and
a tactile relief marking having a bubble structure formed in the foamable synthetic material.

2. The identification document of claim 1, wherein the bubbles contained in the tactile relief marking have diameters that are in a range of up to about 100 um.

3. The identification document of claim 1, further comprising a second surface opposite from the first surface, the second surface being devoid of a negative relief marking directly opposite to the tactile relief marking formed on the first surface.

4. The identification document of claim 1, wherein the relief marking is non-black.

5. The identification document of claim 1, wherein the relief marking has a generally white, generally gold or generally brown color.

6. The identification document of claim 1, wherein the synthetic material comprises polycarbonate.

7. The identification document of claim 1, wherein the relief marking has a color different from other portions of the foamable synthetic material of the first surface.

8. The identification document of claim 1, wherein the identification document contains a plurality of layers, and a marking composed on a layer below the relief marking is visible through the tactile relief marking

9. The identification document of claim 1, wherein a height of the relief marking ranges from about 0.10 mm to about 0.30 mm.

10. The identification document of claim 1, wherein the relief marking has a uniform stroke width.

11. The identification document of claim 1, wherein the relief marking overlaps with a secondary marking.

12. The identification document of claim 1, wherein the secondary marking is a dark marking.

13. A method for producing at least one tactile relief marking on an identification document by an irradiation source, the identification document including a surface having foamable synthetic material that has a property of increasing its volume by foaming upon application of energy, comprising:
selectively irradiating a first surface of the foamable synthetic material with energy from the irradiation source to cause the foamable synthetic material to foam, thereby forming a tactile relief marking on the first surface.

14. The method of claim 13, wherein the irradiation source is a laser source.

15. The method of claim 13, further comprising:
forming a secondary marking on the first surface of the foamable synthetic material,
wherein the secondary marking overlaps at least a portion of the tactile relief marking.

16. The method of claim 15, comprising using the irradiation source to produce the secondary marking on the identification document.

17. The method of claim 15, wherein the secondary marking is a dark marking.

18. The method of claim 13, further comprising adjusting the energy applied by the irradiation source to control a foaming process.

19. The method of claim 18, wherein adjusting the energy applied by the irradiation source to control the foaming process includes adjusting a power level, a pulse density, or a pulse duration of the irradiation source.
